(19) United States
(12) Patent Application Publication
(10) Pub. No.: US 2021/0193149 A1
(43) Pub. Date: Jun. 24, 2021

(54) METHOD, APPARATUS AND DEVICE FOR VOICEPRINT RECOGNITION, AND MEDIUM

(71) Applicant: PING AN TECHNOLOGY (SHENZHEN) CO., LTD., Shenzhen, Guangdong (CN)

(72) Inventors: Jianzong WANG, Shenzhen (CN); Jian LUO, Shenzhen (CN); Hui GUO, Shenzhen (CN); Jing XIAO, Shenzhen (CN)

(21) Appl. No.: 16/091,926

(22) PCT Filed: Feb. 9, 2018
(86) PCT No.: PCT/CN2018/076008

§ 371 Date: Oct. 5, 2018

(30) Foreign Application Priority Data
Jun. 9, 2017 (CN) 201710434570.5

(51) Int. Cl. G10L 17/04; G10L 17/02; G10L 17/06; G10L 25/18

(52) U.S. Cl. CPC G10L 17/04; G10L 25/18; G10L 17/06; G10L 17/02

(57) ABSTRACT

The present solution provides a method, apparatus and device for voiceprint recognition and a medium, which is applicable to the technical field of Internet. The method includes: establishing and training a universal recognition model, wherein the universal recognition model is indicative of a distribution of voice features under a preset communication medium; acquiring voice data under the preset communication medium; creating a corresponding voiceprint vector according to the voice data; and determining a voiceprint feature corresponding to the voiceprint vector according to the universal recognition model. According to the present solution, the voice data is processed by establishing and training the universal recognition model, so that a corresponding voiceprint vector is obtained, a voiceprint feature is determined and a person who makes a sound is recognized according to the voiceprint feature. Since the universal recognition model does not limit contents of the voice, the voiceprint recognition can be used more flexibly and usage scenarios of the voiceprint recognition are increased.

The present application claims the priority of the Chinese Patent Application with Application No. 201710434570.5, filed with State Intellectual Property Office on Jun. 9, 2017, and entitled “METHOD AND APPARATUS FOR VOICEPRINT RECOGNITION”, the content of which is incorporated herein by reference in its entirety.

### TECHNICAL FIELD

The present application relates to the technical field of Internet, and particularly, to a method, an apparatus and a device for voiceprint recognition, and a medium.

### BACKGROUND

In the prior art, when voiceprint feature extraction is performed in the voiceprint recognition process, the accuracy is not high. In order to achieve the accuracy of voiceprint recognition as much as possible, a user is often required to read the specified content, such as reading “one, two, and three”, etc., and to perform voiceprint recognition on the specified content. This method can improve the accuracy of voiceprint recognition to a certain extent. However, this method has a large limitation. Since the user must read the specified content to complete the recognition, the usage scenario of the voiceprint recognition is limited. For example, when forensics is required, it is impossible to require a counterpart to read the specified content.

Aiming at the problem in the related art that voiceprint recognition can only be performed on specified content, and there is no perfect approach to solve this problem in the industry currently.

### SUMMARY

In view of this, embodiments of the present application provide a method, apparatus and device for voiceprint recognition, and a medium, which aims at solving the problem in the related art that voiceprint recognition can only be performed on specified content.

A first aspect of embodiments of the present application provides a method for voiceprint recognition, including:

establishing and training a universal recognition model, wherein the universal recognition model is indicative of a distribution of voice features under a preset communication medium;

acquiring voice data under the preset communication medium;

creating a corresponding voiceprint vector according to the voice data; and

determining a voiceprint feature corresponding to the voiceprint vector according to the universal recognition model.

A second aspect of embodiments of the present application provides an apparatus for voiceprint recognition, including:

an establishing module configured to establish and train a universal recognition model, wherein the universal recognition model is indicative of a distribution of voice features under a preset communication medium;

an acquisition module configured to obtain voice data under the preset communication medium;

a creating module configured to create a corresponding voiceprint vector according to the voice data; and

a recognition module configured to determine a voiceprint feature corresponding to the voiceprint vector according to the universal recognition model.

A third aspect of embodiments of the present application provides a device, including a memory and a processor, the memory stores a computer readable instruction executable on the processor, when executing the computer readable instruction, the processor implements the following steps of:

establishing and training a universal recognition model, wherein the universal recognition model b is indicative of a distribution of voice features under a preset communication medium;

acquiring voice data under the preset communication medium;

creating a corresponding voiceprint vector according to the voice data; and

determining a voiceprint feature corresponding to the voiceprint vector according to the universal recognition model.

A fourth aspect of embodiments of the present application provides a computer readable storage medium which stores a computer readable instruction, wherein when executing the computer readable instruction, a processor implements the following steps of;

establishing and training a universal recognition model, wherein the universal recognition model is indicative of a distribution of voice features under a preset communication medium;

acquiring voice data under the preset communication medium;

creating a corresponding voiceprint vector according to the voice data; and

determining a voiceprint feature corresponding to the voiceprint vector according to the universal recognition model.

According to the present application, a corresponding voiceprint vector is obtained by processing voice data through establishing and training a universal recognition mode, so that a voiceprint feature is determined, and a person who makes a sound is recognized according to the voiceprint feature. Since the universal recognition model does not limit contents of the voice, the voiceprint recognition can be used more flexibly and usage scenarios of the voiceprint recognition are increased.

### BRIEF DESCRIPTION OF DRAWINGS

FIG. 1 illustrates a flow diagram of a method for voiceprint recognition provided by an embodiment of the present application;

FIG. 2 illustrates a schematic diagram of a Mel frequency filter bank provided by an embodiment of the present application;

FIG. 3 illustrates a schematic diagram of a data storage structure provided by an embodiment of the present application;

FIG. 4 illustrates a flow diagram of a method for processing in parallel provided by a preferred embodiment of the present application;

FIG. 5 illustrates a schematic diagram of an apparatus for voiceprint recognition provided by an embodiment of the present application; and

FIG. 6 illustrates a schematic diagram of a device for voiceprint recognition provided by an embodiment of the present application.

### DESCRIPTION OF EMBODIMENTS

In the following description, in order to describe but not intended to limit, concrete details such as specific system structure, technique, and so on are proposed, thereby facilitating comprehensive understanding of the embodiments of the present application. However, it should be clear for the ordinarily skilled one in the art that, the present application can also be implemented in some other embodiments without these concrete details. In some other conditions, detailed explanations of method, circuit, device and system well known to the public are omitted, so that unnecessary details can be prevented from obstructing the description of the present application.

In order to explain the technical solutions described in the present application, the present application will be described with reference to the specific embodiments below.

FIG. 1 is a flow diagram of a voiceprint recognition method provided in an embodiment of the present application. As shown in FIG. 1, the method includes steps 110-140.

Step 110, establishing and training a universal recognition model, wherein the universal recognition model is indicative of a distribution of voice features under a preset communication medium.

The universal recognition model may represent voice feature distributions of all persons under a communication medium (e.g., a microphone or a loudspeaker). The recognition model neither represents voice feature distributions under all communication media nor only represents a voice feature distribution of one person, but represents a voice feature distribution under a certain communication medium. The model includes a set of Gaussian mixture models, the mixture model is a set of voice feature distributions which are irrelevant to a speaker, and the model consists of K Gaussian mixture models in normal distribution to show the voice features of all persons, and K herein is very large, and a general value thereof ranges from tens of thousands to hundreds of thousands, and therefore, the model belongs to large-scale Gaussian mixture models.

Acquisition of the universal recognition model generally includes two steps:

Step 1, establishing an initial recognition model.

The universal recognition model is one of mathematic models and can be used for recognizing a sounding object of any voice data, and users can be distinguished by the model without limiting the speech contents of the users.

The initial recognition model is an initial model of the universal recognition model, that is, a model preliminarily selected for voiceprint recognition. The initial universal recognition model is trained through subsequent steps, and corresponding parameters are adjusted to obtain an ideal universal recognition model.

Operations of selecting the initial model can be done manually, that is, selection can be carried out according to the experience of people, or selection can also be carried out by a corresponding system according to a preset rule.

Taking a simple mathematical model as an example, in a binary coordinate system, if a straight line is modeled, the initial model is y=kx+b, and the model can be selected manually or selected by the corresponding system. The system prestores a corresponding relation table which includes initial models corresponding to various instances. The system selects a corresponding model according to the read information. For example, during graphic function recognition, if the slopes of all points are equal, the system automatically selects the model of y=kx+b according to the corresponding relation table.

After an initial model is determined, the model can be trained based on a certain way to obtain values of the model parameters k and b. For example, by reading the coordinates of any two points on the straight line and substituting the coordinates into the model to train the model, the values of k and b can be obtained so as to obtain an accurate straight line model. In some complicated scenarios, the selection of the initial model may also be preset. For example, if the user selects voiceprint recognition, corresponding initial model A is determined; and if the user selects image recognition, corresponding initial model B is determined. After the initial model is selected, in addition to the relatively simple training ways described above, the initial model may be trained in other ways, such as the method in step 2.

Step 2, training the initial recognition model according to an iterative algorithm to obtain the universal recognition model.

Parameters in the initial recognition model are adjusted through training to obtain a more reasonable universal recognition model.

In the training, likelihood probability p corresponding to a current voiceprint vector represented by a plurality of normal distributions can be obtained first according to the initial recognition model:

p(x|λ)=Σᵢ₌₁^{M}ωᵢpᵢ(x);

the algorithm of the likelihood probability is the initial recognition mode, and voiceprint recognition can be performed by the probability according to a preset corresponding relation, wherein x represents current voice data, λ represents model parameters which include ωᵢ, μᵢ, and Σᵢ, ωᵢ represents a weight of the i-th normal distribution, μᵢ represents a mean value of the i-th normal distribution, Σᵢ represents a covariance matrix of the i-th normal distribution, pᵢ represents a probability of generating the current voice data by the i-th normal distribution, and M is the number of sampling points;

then, a probability of the i-th normal distribution is calculated according to the equation:

$${p}_{i} ( x ) = \frac{1}{{( 2 π )}^{D \text{/} 2} {\vert {Σ}_{i} \vert}^{1 \text{/} 2}} exp \{ - \frac{1}{2} {( x - {μ}_{i} )}^{′} {( {Σ}_{i} )}^{- 1} ( x - {μ}_{i} ) \} ;$$

wherein, D represents the dimension of the current voiceprint vector;

then, parameter values of ωᵢ, μᵢ, and Σᵢ is selected to maximize the log-likelihood function L:

log p(X|λ)=Σₜ₌₁^{T} log p(xₜ|λ);

then, updated model parameters are acquired in each iterative update:

$${ω}_{i}^{′} = \frac{1}{n} {\sum }_{j}^{n} p ( i \vert {x}_{j} , θ )$$

$${μ}_{i}^{′} = \frac{{Σ}_{j}^{n} {x}_{j} p ( i \vert , {x}_{j} , θ )}{{Σ}_{j}^{n} p ( i \vert {x}_{j} , θ )}$$

$${Σ}_{i}^{′} = \frac{{{Σ}_{j}^{n} ( {x}_{j} - {μ}_{i}^{′} )}^{2} p ( i \vert {x}_{j} , θ )}{{Σ}_{j}^{n} p ( i \vert {x}_{j} , θ )} ;$$

Wherein, i represents the i-th normal distribution, ωᵢ′ represents an updated weight of the i-th normal distribution, μᵢ′ represents an updated mean value, Σᵢ′ represents an updated covariance matrix, and θ is an included angle between the voiceprint vector and the horizontal line; and

lastly, a posterior probability of the i-th normal distribution is obtained according to the equation:

$$p ( i \vert {x}_{j} , θ ) = \frac{{ω}_{i} {p}_{i} ( {x}_{j} \vert {θ}_{i} )}{{Σ}_{k}^{M} {ω}_{k} {p}_{k} ( {x}_{j} \vert {θ}_{k} )} ;$$

wherein the sum of posterior probabilities of the plurality of normal distributions is defined as the iterated universal recognition model.

Step S120, acquiring voice data under the preset communication medium.

The sounding object of the voice data in an embodiment of the present application may refer to a person making a sound, and different persons make different sounds. In the embodiment of the present application, the voice data can be obtained by an apparatus for specifically collecting sound. The part where the apparatus collects sound may be provided with a movable diaphragm, a coil is disposed on the diaphragm, and a permanent magnet is arranged below the diaphragm. When a person speaks facing the diaphragm, the coil on the diaphragm moves on the permanent magnet, and the magnetic flux passing through the coil on the diaphragm will change due to the movement of the permanent magnet. Therefore, the coil on the diaphragm generates an induced electromotive force which changes with the change of the acoustic wave, and after the electromotive force passes through an electronic amplifying circuit, a high-power sound signal is obtained.

The high-power sound signal obtained by the foregoing steps is an analog signal, and the embodiment of the present application can further convert the analog signal into voice data.

The step of converting the sound signal into voice data may include sampling, quantization, and coding.

In the sampling step, time-continuous analog signals can be converted into time-discrete and amplitude-continuous signals. The amplitude of the sound signal obtained at certain specific moments is called sampling, and the signals sampled at these specific moments are called discrete time signals. In general, sampling is made at equal intervals, the time interval is called a sampling period, and a reciprocal of the time interval is called a sampling frequency. The sampling frequency should not be less than two times the highest frequency of the sound signal.

In the quantization step, each sample of consecutively taking values in amplitude is converted into a discrete value representation, and therefore, the quantization process is sometimes called analog/digital (A/D for short) conversion.

In the coding step, the sampling usually has three standard frequencies: 44.1 khz, 22.05 khz, and 11.05 khz. The quantization accuracy of the sound signal is generally 8b, 12b, 16b, the data rate is in kb/s, and the compression ratio is generally greater than 1.

Voice data converted from the sound of the sounding object can be obtained through the foregoing steps.

Step S130, creating a corresponding voiceprint vector according to the voice data.

The objective of creating the voiceprint vector is to extract the voiceprint feature from the voice data, that is, regardless of the speech content, the corresponding sounding object can be recognized by the voice data.

In order to accurately recognize the human voice, the embodiment of the present application adopts a voiceprint vector representation method based on a Mel frequency filter, and the Mel frequency is more similar to the human auditory system than a linearly spaced frequency band in the normal logarithmic cepstrum, so that the sound can be better represented.

In the embodiment of the present application, a set of band-pass filters are arranged from dense to sparse within a frequency band from low frequency to high frequency according to the critical bandwidth to filter the voice data, and the signal energy output by each band-pass filter is used as the basic feature of the voice data. This feature can be used as a vector component of the voice data after being further processed. Since this vector component is independent of the property of the voice data, no assumption or limitation is made to the input voice data, and the research results of an auditory model are utilized, and therefore, compared with other representation methods, for example, the linear channel features have better robustness, the embodiment of the present application better conforms to the auditory characteristics of the human ear, and still has better recognition performance when the signal-to-noise ratio is lowered.

Particularly, in order to create a Mel frequency-based vector, each voice can be divided into a plurality of frames, each of which corresponds to a spectrum (by short-time fast Fourier calculation, i.e., FFT calculation), and the frequency spectrum represents the relationship of the frequency and the energy. For uniform presentation, an auto-power spectrum can be adopted, that is, the amplitude of each spectral line is logarithmically calculated, so the unit of the ordinate is dB (decibel), and through such transformation, the components with lower amplitude are pulled high relative to the components with relatively high amplitude, so as to observe a periodic signal that is masked in low amplitude noise.

After the transformation, the voice in the original time domain can be represented in the frequency domain, and the peak value therein is called the formant. The embodiment of the present application can use the formant to construct the voiceprint vector. In order to extract the formant and filter out the noise, the embodiment of the present application uses the following equation:

log X[k]=log H[k]+log E[k];

wherein, X[k] represents the original voice data, H[k] represents the formant, and E[k] represents the noise.

In order to achieve this equation, the embodiment of the present application uses the inverse Fourier transform, i.e., IFFT. The formant is converted to a low time domain interval, and a low-pass filter is loaded to obtain the formant. For the filter, this embodiment uses the Mel frequency equation below:

Mel(f)=2595*log₁₀(1+f/700);

wherein, Mel(f) represents the Mel frequency at frequency f.

In the implementation process, in order to meet the post processing requirements, the embodiment of the present application carries out a series of pre-processing on the voice data, such as pre-emphasis, framing, and windowing. The pre-processing may include the following steps:

Step 1, performing pre-emphasis on the voice data.

The embodiment of the present application first passes the voice data through a high-pass filter:

H(Z)=1−μz⁻¹;

wherein, the value of μ is between 0.9 and 1.0, and the embodiment of the present application takes an empirical constant 0.97. The objective of pre-emphasis is to raise the high-frequency portion, flatten the spectrum of the signal, and maintain the spectrum in the entire frequency band from low frequency to high frequency, and the spectrum can be calculated by the same signal-to-noise ratio. At the same time, the effect of the vocal cords and lips in the genesis process can also be eliminated to compensate for the high-frequency portion of the voice signal that is suppressed by a sounding system, and also to highlight the high-frequency formant.

Step 2, framing the voice data.

In this step, N sampling points are first grouped into one observation unit, and the data collected by the observation unit per unit time is one frame. Usually, the value of N is 256 or 512, and the unit time is about 20-30 ms. In order to avoid great change of two adjacent frames, an overlapping area will exist between two adjacent frames. The overlapping area includes M sampling points, and generally, the value of M is about ½ or ⅓ of N. Generally, the sampling frequency of voice data used in the voice recognition is 8 KHz or 16 KHz. In the case of 8 KHz, if the frame length is 256 sampling points, the corresponding time length is 256/8000*1000=32 ms.

Step 3, windowing the voice data.

Each frame of voice data is multiplied by a Hamming window, thus increasing the continuity of the left and right ends of the frame. Assuming that the framed voice data is S(n), n=0, 1, . . . , N−1, N is the size of the frame, then after multiplication by the Hamming window, S′(n)=S(n)×W(n), the Hamming window algorithm W(n) is as follows:

$$W ( n , a ) = ( 1 - a ) - a \times cos [ \frac{2 π n}{N - 1} ] , 0 \leq n \leq N - 1 ;$$

Different values of a will result in different Hamming windows. In the embodiment of the present application, the a takes 0.46.

Step 4, performing fast Fourier transform on the voice data.

After the Hamming window is added, the voice data can generally be converted into an energy distribution in the frequency domain for observation, and different energy distributions can represent the characteristics of different voices. Therefore, after multiplication by the Hamming window, each frame must also undergo a fast Fourier transform to obtain the energy distribution on the spectrum. Fast Fourier transform is performed on each frame of the framed and windowed data to obtain the spectrum of each frame, and the frequency spectrum of the voice data is subjected to modular square to obtain the power spectrum of the voice data, and the Fourier transform (DFT) equation of the voice data is as follows:

Xₐ(k)=Σₙ₌₀^{N-1}x(n)e^{-jπk/N},0≤k≤N;

wherein, x(n) represents input voice data, and N represents the number of Fourier transform points.

Step 5, inputting the voice data into a triangular band-pass filter.

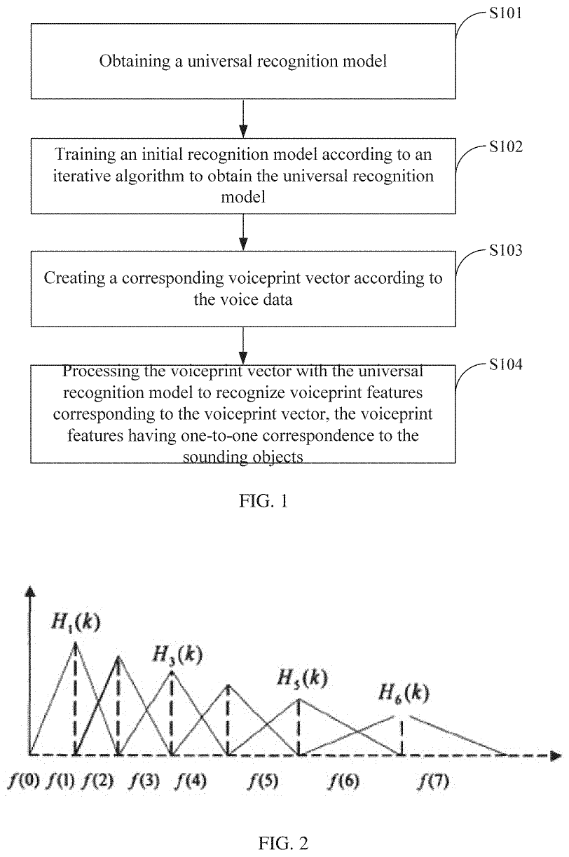

In this step, the energy spectrum can be passed through a set of Mel-scale triangular filter banks. The embodiment of the present application defines a filter bank with M filters (the number of filters and the number of critical bands are similar). The used filter is a triangular filter with a center frequency of f(m), m=1, 2, . . . , M. FIG. 2 is a schematic diagram of a Mel frequency filter bank provided in an embodiment of the present application. As shown in FIG. 2, M may take 22-26. The interval between each f(m) decreases as the value of m decreases, and widens as the value of m increases.

The frequency response of the triangular filter is defined as follows:

$${H}_{m} ( k ) = \{ \begin{matrix}0 , when k < f ( m - 1 ) \\ \frac{2 ( k - f ( m - 1 ) )}{( f ( m + 1 ) - f ( m - 1 ) ) ( f ( m ) - f ( m - 1 ) )} , when f ( m - 1 ) \leq k \leq f ( m ) \\ \frac{2 ( f ( m + 1 ) - k )}{( f ( m + 1 ) - f ( m - 1 ) ) ( f ( m ) - f ( m - 1 ) )} , when f ( m ) \leq k \leq f ( m + 1 ) \\ 0 , k \geq f ( m + 1 )\end{matrix}$$

wherein, f(x) represents frequency x, Σₘ₌₀^{M-1}Hₘ(k)=1, the triangular filter is used for smoothing the frequency spectrum and eliminating the harmonic function to highlight the formant of the voice. Therefore, the tone or pitch of a voice is not presented in the Mel frequency cepstrum coefficient (MFCC coefficient for short), that is, the voice recognition system characterized by MFCC is not influenced by different tones of the input voice. In addition, the triangular filter can also reduce the computation burden.

Step 6, calculating the logarithmic energy output by each filter bank according to the equation:

$$s ( m ) = ln ( {\sum }_{k = 0}^{N - 1} {\vert {X}_{a} ( k ) \vert}^{2} {H}_{m} ( k ) ) , 0 \leq m \leq M$$

wherein, s(m) is the logarithmic energy.

Step 7, obtaining the MFCC coefficient by discrete cosine transform (DCT):

$$C ( n ) = {\sum }_{m = 0}^{N - 1} s ( m ) cos ( \frac{π n ( m - 0.5 )}{M} ) , n = 1 , 2 , … , L$$

wherein, C(n) represents the n-th MFCC coefficient.

The foregoing logarithmic energy is substituted into the discrete cosine transform to obtain the Mel cepstrum parameters of the L-order. The order usually takes 12-16. M herein is the number of the triangular filters.

Step 8, calculating the logarithmic energy.

The volume of a frame of voice data is the energy, is also an important feature and is easy to calculate. Therefore, the logarithmic energy of a frame of voice data is generally added, that is, the sum of squares in a frame of voice data, and then the logarithmic value with the base of 10 is taken to be multiplied by 10. By this step, the basic voice feature of each frame has one more dimension, including a logarithmic energy and the remaining cepstrum parameters.

Step 9, extracting a dynamic difference parameter.

The embodiment of the present application provides a first-order difference and a second-order difference. The standard MFCC coefficients only reflect the static features of the voice, and the dynamic features of the voice can be described by the differential spectrum of these static features. Combining dynamic and static features can effectively improve the recognition performance of the system. The calculation of differential parameters can be performed by using the following equation:

$${d}_{t} = \{ \begin{matrix}{C}_{t + 1} - {C}_{t} , t < K \\ \frac{{\sum }_{k = 1}^{K} k ( {C}_{t + k} - {C}_{t - k} )}{\sqrt{2 {\sum }_{k = 1}^{K} {k}^{2}}} , others \\ {C}_{t} - {C}_{t - 1} , t \geq Q - K\end{matrix}$$

wherein, dt represents the t-th first-order difference, Ct represents the t-th cepstrum coefficient, Q represents the order of the cepstrum coefficient, and K represents the time difference of the first-order derivative and may take 1 or 2. By substituting the results of the equation above, the parameters of the second-order difference can be obtained.

The foregoing dynamic difference parameter is the vector component of the voiceprint vector, from which the voiceprint vector can be determined.

Step S140, determining a voiceprint feature corresponding to the voiceprint vector according to the universal recognition model.

Generally, in the prior art, calculation is carried out by a central processing unit (CPU for short) to determine a voiceprint feature, while in the embodiment of the present application, a graphics processing unit (GPU for short) which is not used at a high rate is utilized to carry out the processing of voiceprint vectors.

The CPU generally has a complicated structure, and generally can handle simple operations and can also be responsible for maintaining the operation of the entire system. The GPU has simple structure and generally can only be used for simple operations, and a plurality of GPUs can be used in parallel.

If too many CPU resources are used to handle simple operations, then the operation of the entire system may be affected. Since the GPU is not responsible for the operation of the system, and the number of GPUs is much larger than that of CPUs, if the GPU can process the voiceprint vector, it can share part of the pressure of the CPU, so that the CPU can use more resources to maintain the normal operation of the system. The embodiment of the present application can process the voiceprint vectors in parallel by using a plurality of GPUs. To achieve this objective, the following two operations are required:

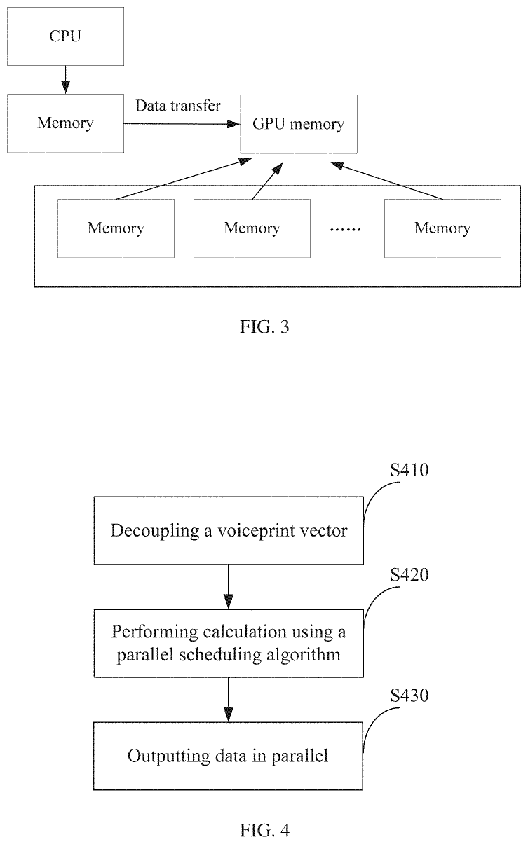

On the one hand, the embodiment of the present application re-determines the data storage structure, that is, the main data is transferred from the memory (dual data rate, DDR for short) to the GPU memory (graphics double data rate, GDDR for short). FIG. 3 is a schematic diagram of a data storage structure provided in an embodiment of the present application. As shown in FIG. 3, in the prior art, data is stored in a memory for the CPU to read. In the embodiment of the present application, the data in the memory is transferred to the GPU memory for the GPU to read.

The advantage of data dumping is: all stream processors of the GPU can access the data. Considering that the current GPU generally has more than 1,000 stream processors, storing the data in GPU memory can make full use of the efficient computing capability of the GPU, so that the response delay is lower and the calculation speed is faster.

On the other hand, the embodiment of the present application provides a parallel processing algorithm of the GPU to carry out parallel processing on the voiceprint vector. FIG. 4 is a flow diagram of a parallel processing method provided in a preferred embodiment of the present application. As shown in FIG. 4, the method includes:

Step S410, decoupling the voiceprint vector.

According to the preset decoupling algorithm, the sequential loop step in the original processing algorithm can be turned on. For example, during calculation of the FFT algorithm of each frame, we can perform decoupling by setting the thread offset algorithm, so as to calculate all the voiceprint vectors and make all the voiceprint vectors in parallel.

Step S420, processing in parallel the voiceprint vector using a plurality of graphics processing units to obtain a plurality of processing results.

After the decoupling, the GPU computing resources, such as the GPU stream processors, a constant memory, and a texture memory, can be fully utilized to carry out parallel computing according to a preset scheduling algorithm. In the scheduling algorithm, the scheduling resources are allocated as an integer multiple of a thread beam of the GPU, and at the same time cover all the GPU memory data needed to be calculated as much as possible, to achieve the optimal calculation efficiency requirements.

Step S430, combining the plurality of processing results to determine the voiceprint feature.

After a plurality of GPUs carry out parallel processing on the voiceprint vectors, the processing results are merged to quickly determine the voiceprint features. The combination operation and the foregoing decoupling operation may be reversible.

Considering that the last human-computer interaction is based on the host memory, the embodiment of the present application finally utilizes a parallel copy algorithm to execute the copy program through a parallel GPU thread, thereby maximizing the use of the PCI bus bandwidth of the host and reducing the data transmission delay.

According to the embodiment of the present application, a corresponding voiceprint vector is obtained by processing the voice data through establishing and training a universal recognition model, so that a voiceprint feature is determined, and a person who makes a sound can be recognized according to the voiceprint feature. Since the universal recognition model does not limit contents of the voice, the voiceprint recognition can be used more flexibly and usage scenarios of the voiceprint recognition are increased.

It should be understood that the size of the serial number of each step in the foregoing embodiments does not mean the order of execution. The order of execution of each process should be determined by the function and internal logic thereof, and should not be interpreted as limiting the implementation process of the embodiments of the present application.

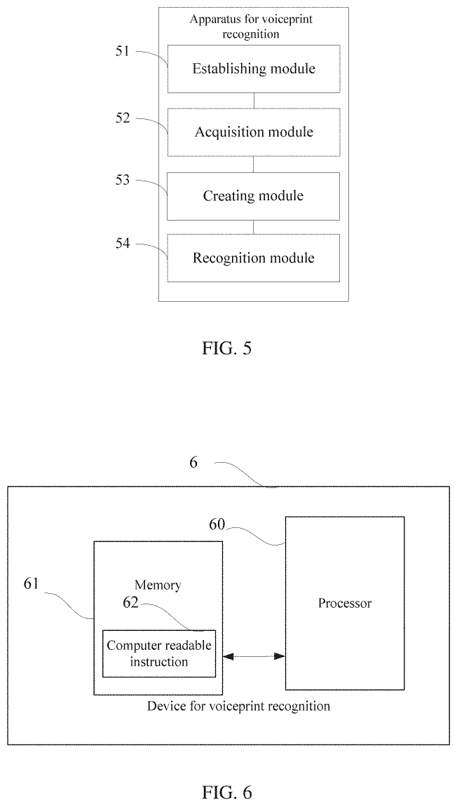

Corresponding to the voiceprint recognition method in the foregoing embodiment, FIG. 5 illustrates a structure diagram of a voiceprint recognition apparatus provided in an embodiment of the present application. For the sake of illustration, only the parts related to the embodiment of the present application are shown.

Referring to FIG. 5, the apparatus includes:

an establishing module 51 configured to establish and train a universal recognition model, the universal recognition model is indicative of a distribution of voice features under a preset communication medium;

an acquiring module 52 configured to obtain voice data under the preset communication medium;

a establishing module 53 configured to construct a corresponding voiceprint vector according to the voice data; and

a recognition module 54 configured to determine a voiceprint feature corresponding to the voiceprint vector according to the universal recognition model.

Preferably, the establishing module 51 includes:

an establishing sub-module configured to establish an initial recognition model; and

a training sub-module configured to train the initial recognition model according to an iterative algorithm to obtain the universal recognition model.

Preferably, the training sub-module is configured to:

obtain likelihood probability p corresponding to a current voiceprint vector represented by a plurality of normal distributions according to the initial recognition model

p(x|λ)=Σᵢ₌₁^{M}ωᵢpᵢ(x);

wherein, xᵢ, represents current voice data, λ represents model parameters which includes ωᵢ, μᵢ, and Σᵢ ωᵢ represents a weight of the i-th normal distribution, μᵢ represents a mean value of the i-th normal distribution, Σᵢ represents a covariance matrix of the i-th normal distribution, pᵢ represents a probability of generating the current voice data by the i-th normal distribution, and M is the number of sampling points;

calculate a probability of the i-th normal distribution according to the equation

$${p}_{i} ( x ) = \frac{1}{{( 2 π )}^{D \text{/} 2} {\vert {Σ}_{i} \vert}^{1 \text{/} 2}} exp \{ - \frac{1}{2} {( x - {μ}_{i} )}^{′} {( {Σ}_{i} )}^{- 1} ( x - {μ}_{i} ) \} ;$$

wherein, D represents the dimension of the current voiceprint vector;

select parameter values of ωᵢ, μᵢ, and Σᵢ to maximize the log-likelihood function L:

log p(X|λ)=Σₜ₌₁^{T} log p(xₜ|λ);

obtain updated model parameters in each iterative update:

$${ω}_{i}^{′} = \frac{1}{n} {\sum }_{j}^{n} p ( i \vert {x}_{j} , θ )$$

$${μ}_{i}^{′} = \frac{{Σ}_{j}^{n} {x}_{j} p ( i \vert {x}_{j} , θ )}{{Σ}_{j}^{n} p ( i \vert {x}_{j} , θ )}$$

$${Σ}_{i}^{′} = \frac{{{Σ}_{j}^{n} ( {x}_{j} - {μ}_{i}^{′} )}^{2} p ( i \vert {x}_{j} , θ )}{{Σ}_{j}^{n} p ( i \vert {x}_{j} , θ )} ;$$

wherein, i represents the i-th normal distribution, ωᵢ′ represents an updated weight of the i-th normal distribution, μᵢ′ represents an updated mean value, Σᵢ′ represents an updated covariance matrix, and θ is an included angle between the voiceprint vector and the horizontal line; and

obtain a posterior probability of the i-th normal distribution according to the equation:

$$p ( i \vert {x}_{j} , θ ) = \frac{{ω}_{i} {p}_{i} ( {x}_{j} \vert {θ}_{i} )}{{Σ}_{k}^{M} {ω}_{k} {p}_{k} ( {x}_{j} \vert {θ}_{k} )} ;$$

wherein, the sum of posterior probabilities of the plurality of normal distributions is defined as the iterated universal recognition model.

Preferably, the establishing module 53 is configured to perform fast Fourier transform on the voice data, the fast Fourier transform formula is formulated as:

$${X}_{a} ( k ) = {\sum }_{n = 0}^{N - 1} x ( n ) {e}^{- j 2 π k \text{/} N} , 0 \leq k \leq N$$

wherein, x(n) represents input voice data, and N represents the number of Fourier transform points.

Preferably, the recognition module 54 includes:

a decoupling sub-module configured to decouple the voiceprint vector;

an acquiring sub-module configured to process in parallel the voiceprint vector using a plurality of graphics processing units to obtain a plurality of processing results; and

a combination sub-module configured to combine the plurality of processing results to determine the voiceprint feature.

According to the embodiment of the present application, a corresponding voiceprint vector is obtained by processing the voice data through establishing and training a universal recognition model, so that a voiceprint feature is determined, and a person who makes a sound is recognized according to the voiceprint feature. Since the universal recognition model does not limit contents of the voice, the voiceprint recognition can be used more flexibly and usage scenarios of the voiceprint recognition are increased.

FIG. 6 is a schematic diagram of a voiceprint recognition device provided in an embodiment of the present application. As shown in FIG. 6, in this embodiment, the voiceprint recognition device 6 includes a processor 60 and a memory 61; the memory 61 stores a computer readable instruction 62 executable on the processor 60, that is, a computer program for recognizing the voiceprint. When the processor 60 executes the computer readable instruction 62, the steps (e.g., steps S110 to S140 shown in FIG. 1) in the foregoing embodiments of the various burst topic detection methods are implemented; as an alternative, when the processor 60 executes the computer readable instructions 62, the functions (e.g., the functions of modules 51 to 54 shown in FIG. 5) of various modules/units in the foregoing embodiments of the device are implemented.

Exemplarily, the computer readable instruction 62 may be divided into one or more modules/units that are stored in the memory 61 and executed by the processor 60 so as to complete the present application. The one or more modules/units may be a series of computer readable instruction segments capable of completing particular functions for describing the execution process of the computer readable instructions 62 in the voiceprint recognition device 6. For example, the computer readable instructions 62 may be divided into an establishing module, an acquisition module, a creating module, and a recognition module, and the specific functions of the modules are as below.

The establishing module is configured to establish and train a universal recognition model, the universal recognition model is indicative of a distribution of voice features under a preset communication medium.

The acquisition module is configured to acquire voice data under the preset communication medium.

The creating module is configured to create a corresponding voiceprint vector according to the voice data.

The recognition module is configured to determine a voiceprint feature corresponding to the voiceprint vector according to the universal recognition model.

The voiceprint recognition device 6 may be a computing apparatus such as a desktop computer, a notebook, a palmtop computer, and a cloud server. It can be understood by those skilled in the art that FIG. 6 is merely an example of the voiceprint recognition device 6, and should not be interpreted as limiting the voiceprint recognition device 6, may include more or fewer components than the illustration, or may combine some components, or different components. For example, the voiceprint recognition device may also include input/output devices, network access devices, buses, and so on.

The processor 60 may be a central processing unit (CPU), or may be other general-purpose processors, a digital signal processor (DSP), an application specific integrated circuit (ASIC), a field-programmable gate array (FPGA) or other programmable logic device, a discrete gate or transistor logic device, discrete hardware components, etc. The general-purpose processor may be a microprocessor, or the processor may also be any conventional processor or the like.

The memory 61 may be an internal storage unit of the voiceprint recognition device 6, such as a hard disk or memory of the voiceprint recognition device 6. The memory 61 may also be an external storage device of the voiceprint recognition device 6, for example, a plug-in hard disk equipped on the voiceprint recognition device 6, a smart memory card (SMC), a secure digital (SD) card, a flash card, etc. Furthermore, the memory 61 may also include both an internal storage unit of the voiceprint recognition device 6 and an external storage device. The memory 61 is configured to store the computer readable instructions and other programs and data required by the voiceprint recognition device. The memory 61 can also be configured to temporarily store data that has been output or is about to be output.

In addition, functional units in various embodiments of the present application may be integrated into one processing unit, or each of the units may exist alone physically, or two or more units are integrated into one unit. The foregoing integrated unit may be implemented in a form of hardware, or may be implemented in a form of a software functional unit.

When the integrated unit is implemented in the form of a software functional unit and sold or used as an independent product, the integrated unit may be stored in a computer readable storage medium. Based on such understanding, the technical solutions of the present application essentially, or the part contributing to the prior art, or all or a part of the technical solutions may be implemented in the form of a software product. The software product is stored in a storage medium and includes a plurality of instructions for instructing a computer device (which may be a personal computer, a server, a network device, etc.) to perform all or some of the steps of the methods described in the embodiments of the present application. The foregoing storage medium includes: any medium that can store program code, such as a USB flash drive, a removable hard disk, a read-only memory (ROM), a random access memory (RAM), a magnetic disk, or an optical disc.

As stated above, the foregoing embodiments are merely used to explain the technical solutions of the present application, and are not limited thereto. Although the present application has been described in detail with reference to the foregoing embodiments, those skilled in the art should understand that the technical solutions described in the foregoing embodiments can still be modified, or equivalent replacement can be made to some of the technical features. Moreover, these modifications or substitutions do not make the essences of corresponding technical solutions depart from the spirit and scope of the technical solutions of the embodiments of the present application.

1. A method for voiceprint recognition, comprising:
establishing and training a universal recognition model, wherein the universal recognition model is indicative of a distribution of voice features under a preset communication medium;
acquiring voice data under the preset communication medium;
creating a corresponding voiceprint vector according to the voice data; and
determining a voiceprint feature corresponding to the voiceprint vector according to the universal recognition model.

2. The method according to claim 1, wherein the step of establishing and training a universal recognition model comprises:
establishing an initial recognition model; and
training the initial recognition model according to an iterative algorithm to obtain the universal recognition model.

3. The method according to claim 2, wherein the step of training the initial recognition model according to an iterative algorithm to obtain the universal recognition model comprises:
acquiring likelihood probability p corresponding to a current voiceprint vector represented by a plurality of normal distributions according to the initial recognition model:
p(x|λ)=Σᵢ₌₁^{M}ωᵢpᵢ(x);
wherein, x represents current voice data, λ represents model parameters which include ωᵢ, μᵢ, and Σᵢ, ωᵢ represents a weight of a i-th normal distribution, μᵢ represents a mean value of the i-th normal distribution, Σᵢ represents a covariance matrix of the i-th normal distribution, pᵢ represents a probability of generating the current voice data by the i-th normal distribution, and M is the number of sampling points;
calculating a probability of the i-th normal distribution according to the equation:
$${p}_{i} ( x ) = \frac{1}{{( 2 π )}^{D \text{/} 2} {\vert {Σ}_{i} \vert}^{1 \text{/} 2}} exp \{ - \frac{1}{2} {( x - {μ}_{i} )}^{′} {( {Σ}_{i} )}^{- 1} ( x - {μ}_{i} ) \} ,$$
wherein, D represents the dimension of the current voiceprint vector;
selecting parameter values of ωᵢ, μᵢ, and Σᵢ to maximize the log-likelihood function L:
log p(X|λ)=Σₜ₌₁^{T} log p(xₜ|λ);
acquiring updated model parameters in each iterative update:
$${ω}_{i}^{′} = \frac{1}{n} {\sum }_{j}^{n} p ( i \vert {x}_{j} , θ )$$
$${μ}_{i}^{′} = \frac{{Σ}_{j}^{n} {x}_{j} p ( i \vert {x}_{j} , θ )}{{Σ}_{j}^{n} p ( i \vert {x}_{j} , θ )}$$
$${Σ}_{i}^{′} = \frac{{{Σ}_{j}^{n} ( {x}_{j} - {μ}_{i}^{′} )}^{2} p ( i \vert {x}_{j} , θ )}{{Σ}_{j}^{n} p ( i \vert {x}_{j} , θ )} ;$$
wherein, i represents the i-th normal distribution, ωᵢ′ represents an updated weight of the i-th normal distribution, μᵢ′ represents an updated mean value, Σᵢ′ represents an updated covariance matrix, and θ is an included angle between the voiceprint vector and the horizontal line; and
acquiring a posterior probability of the i-th normal distribution according to the equation:
$$p ( i \vert {x}_{j} , θ ) = \frac{{ω}_{i} {p}_{i} ( {x}_{j} \vert {θ}_{i} )}{{Σ}_{k}^{M} {ω}_{k} {p}_{k} ( {x}_{j} \vert {θ}_{k} )} ,$$
wherein, the sum of posterior probabilities of the plurality of normal distributions is defined as the iterated universal recognition model.

4. The method according to claim 1, wherein the step of creating a corresponding voiceprint vector according to the voice data comprises:
performing fast Fourier transform on the voice data, the fast Fourier transform equation is formulated as:
Xₐ(k)=Σₙ₌₀^{N-1}x(n)e^{-jπk/N},0≤k≤N;
wherein, x(n) represents input voice data, and N represents the number of Fourier transform points.

5. The method according to claim 1, wherein the step of determining a voiceprint feature corresponding to the voiceprint vector according to the universal recognition model comprises:
decoupling the voiceprint vector;
processing in parallel the voiceprint vector using a plurality of graphics processing units to obtain a plurality of processing results; and
combining the plurality of processing results to determine the voiceprint feature.

6-10. (canceled)

11. A device for voiceprint recognition, comprising a memory and a processor, wherein a computer readable instruction capable of running on the processor is stored in the memory, and when executing the computer readable instruction, the processor implements following steps of:
establishing and training a universal recognition model, the universal recognition model being used for representing distribution of voice features under a preset communication medium;
acquiring voice data under the preset communication medium;
creating a corresponding voiceprint vector according to the voice data; and
determining a voiceprint feature corresponding to the voiceprint vector according to the universal recognition model.

12. The device according to claim 11, wherein the step of establishing and training a universal recognition model comprises:
establishing an initial recognition model; and
training the initial recognition model according to an iterative algorithm to obtain the universal recognition model.

13. The device according to claim 12, wherein the step of training the initial recognition model according to an iterative algorithm to obtain the universal recognition model comprises:
acquiring likelihood probability p corresponding to a current voiceprint vector represented by a plurality of normal distributions according to the initial recognition model:
p(x|λ)=Σᵢ₌₁^{M}ωᵢpᵢ(x);
wherein, x represents current voice data, λ represents model parameters which include ωᵢ, μᵢ, and Σᵢ, ωᵢ represents a weight of the i-th normal distribution, μᵢ represents a mean value of the i-th normal distribution, Σᵢ represents a covariance matrix of the i-th normal distribution, pᵢ represents a probability of generating the current voice data by the i-th normal distribution, and M is the number of sampling points;
calculating a probability of the i-th normal distribution according to the equation:
$${p}_{i} ( x ) = \frac{1}{{( 2 π )}^{D \text{/} 2} {\vert {Σ}_{i} \vert}^{1 \text{/} 2}} exp \{ - \frac{1}{2} {( x - {μ}_{i} )}^{′} {( {Σ}_{i} )}^{- 1} ( x - {μ}_{i} ) \} ;$$
wherein, D represents the dimension of the current voiceprint vector;
selecting parameter values of ωᵢ, μᵢ, and Σᵢ to maximize the log-likelihood function L:log p(X|λ)=Σₜ₌₁^{T} log p(xₜ|λ);
acquiring updated model parameters in each iterative update:
$${ω}_{i}^{′} = \frac{1}{n} {\sum }_{j}^{n} p ( i \vert {x}_{j} , θ )$$
$${μ}_{i}^{′} = \frac{{Σ}_{j}^{n} {x}_{j} p ( i \vert {x}_{j} , θ )}{{Σ}_{j}^{n} p ( i \vert {x}_{j} , θ )}$$
$${Σ}_{i}^{′} = \frac{{{Σ}_{j}^{n} ( {x}_{j} - {μ}_{i}^{′} )}^{2} p ( i \vert {x}_{j} , θ )}{{Σ}_{j}^{n} p ( i \vert {x}_{j} , θ )} ,$$
wherein, i represents the i-th normal distribution, ωᵢ′ represents an updated weight of the i-th normal distribution, μᵢ′ represents an updated mean value, Σᵢ′ represents an updated covariance matrix, and θ is an included angle between the voiceprint vector and the horizontal line; and
acquiring a posterior probability of the i-th normal distribution according to the equation:
$$p ( i \vert {x}_{j} , θ ) = \frac{{ω}_{i} {p}_{i} ( {x}_{j} \vert {θ}_{i} )}{{Σ}_{k}^{M} {ω}_{k} {p}_{k} ( {x}_{j} \vert {θ}_{k} )} ;$$
wherein, the sum of posterior probabilities of the plurality of normal distributions is defined as the iterated universal recognition model.

14. The device according to claim 11, wherein the step of creating a corresponding voiceprint vector according to the voice data comprises:
performing fast Fourier transform on the voice data, the fast Fourier transform equation is formulated as:
Xₐ(k)=Σₙ₌₀^{N-1}x(n)e^{-jπk/N},0≤k≤N;
wherein, x(n) represents input voice data, and N represents the number of Fourier transform points.

15. The device according to claim 11, wherein the step of determining a voiceprint feature corresponding to the voiceprint vector according to the universal recognition model comprises:
decoupling the voiceprint vector;
processing the voiceprint vector in parallel using a plurality of graphics processing units to obtain a plurality of processing results; and
combining the plurality of processing results to determine the voiceprint feature.

16. A computer readable storage medium which stores a computer readable instruction, wherein when executing the computer readable instruction, at least one processor implements the following steps of:
establishing and training a universal recognition model, wherein the universal recognition model is indicative of a distribution of voice features under a preset communication medium;
acquiring voice data under the preset communication medium;
creating a corresponding voiceprint vector according to the voice data; and
determining a voiceprint feature corresponding to the voiceprint vector according to the universal recognition model.

17. The computer readable storage medium according to claim 16, wherein the step of establishing and training a universal recognition model comprises:
establishing an initial recognition model; and
training the initial recognition model according to an iterative algorithm to obtain the universal recognition model.

18. The computer readable storage medium according to claim 17, wherein the step of training the initial recognition model according to an iterative algorithm to obtain the universal recognition model comprises:
acquiring likelihood probability p corresponding to a current voiceprint vector represented by a plurality of normal distributions according to the initial recognition model:
p(x|λ)=Σᵢ₌₁^{M}ωᵢpᵢ(x);
wherein x represents current voice data, λ represents model parameters which include ωᵢ, μᵢ, and ωᵢ represents a weight of the i-th normal distribution, μᵢ represents a mean value of the i-th normal distribution, Σᵢ represents a covariance matrix of the i-th normal distribution, pᵢ represents a probability of generating the current voice data by the i-th normal distribution, and M is the number of sampling points;
calculating a probability of the i-th normal distribution according to the equation:
$${p}_{i} ( x ) = \frac{1}{{( 2 π )}^{D \text{/} 2} {\vert {Σ}_{i} \vert}^{1 \text{/} 2}} exp \{ - \frac{1}{2} {( x - {μ}_{i} )}^{′} {( {Σ}_{i} )}^{- 1} ( x - {μ}_{i} ) \} ;$$
wherein, D represents the dimension of the current voiceprint vector;
selecting parameter values of ωᵢ, μᵢ, and Σᵢ to maximize the log-likelihood function L:
log p(X|λ)=Σₜ₌₁^{T} log p(xₜ|λ);
acquiring updated model parameters in each iterative update:
$${ω}_{i}^{′} = \frac{1}{n} {\sum }_{j}^{n} p ( i \vert {x}_{j} , θ )$$
$${μ}_{i}^{′} = \frac{{Σ}_{j}^{n} {x}_{j} p ( i \vert {x}_{j} , θ )}{{Σ}_{j}^{n} p ( i \vert {x}_{j} , θ )}$$
$${Σ}_{i}^{′} = \frac{{{Σ}_{j}^{n} ( {x}_{j} - {μ}_{i}^{′} )}^{2} p ( i \vert {x}_{j} , θ )}{{Σ}_{j}^{n} p ( i \vert {x}_{j} , θ )} ;$$
wherein, i represents the i-th normal distribution, ωᵢ′ represents an updated weight of the i-th normal distribution, μᵢ′ represents an updated mean value, Σᵢ′ represents an updated covariance matrix, and θ is an included angle between the voiceprint vector and the horizontal line; and
acquiring a posterior probability of the i-th normal distribution according to the equation:
$$p ( i \vert {x}_{j} , θ ) = \frac{{ω}_{i} {p}_{i} ( {x}_{j} \vert {θ}_{i} )}{{Σ}_{k}^{M} {ω}_{k} {p}_{k} ( {x}_{j} \vert {θ}_{k} )} ;$$
wherein, the sum of posterior probabilities of the plurality of normal distributions is defined as the iterated universal recognition model.

19. The computer readable storage medium according to claim 16, wherein the step of creating a corresponding voiceprint vector according to the voice data comprises:
performing fast Fourier transform on the voice data, the fast Fourier transform equation is formulated as:
$${X}_{a} ( k ) = {\sum }_{n = 0}^{N - 1} x ( n ) {e}^{- j 2 π k \text{/} N} , 0 \leq k \leq N$$
wherein, x(n) represents input voice data, and N represents the number of Fourier transform points.

20. The computer readable storage medium according to claim 16, wherein the step of determining a voiceprint feature corresponding to the voiceprint vector according to the universal recognition model comprises:
decoupling the voiceprint vector;
processing the voiceprint vector in parallel using a plurality of graphics processing units to obtain a plurality of processing results; and
combining the plurality of processing results to determine the voiceprint feature.
